(19) United States
(12) Patent Application Publication
(10) Pub. No.: US 2015/0307393 A1
(43) Pub. Date: Oct. 29, 2015

(54) METHOD FOR PREPARING AN OPTIONALLY FUNCTIONALISED GLASS HAVING BIMODAL POROSITY, AND SAID GLASS

(71) Applicants: COMMISSARIAT À L'ÉNERGIE ATOMIQUE ET AUX ÉNERGIES ALTERNATIVES, Paris (FR); UNIVERSITÉ MONTPELLIER 2 SCIENCES ET TECHNIQUES, MONTPELLIER cedex 5 (FR); CENTRE NATIONAL DE LA RECHERCHE SCIENTIFIQUE, Paris Cedex 16 (FR)

(72) Inventors: Marie Guillot, Chatenoy Le Royal (FR); Frédéric Goettmann, Les Angles (FR); Carole Delchet, Saint Nazaire (FR); Sabah El Mourabit, Sorgues (FR); Agnés Grandjean, Saint Marcel De Careiret (FR)

(21) Appl. No.: 14/647,782

(22) PCT Filed: Nov. 29, 2013
(86) PCT No.: PCT/EP2013/075105

§ 371 Date: May 27, 2015

(30) Foreign Application Priority Data
Nov. 30, 2012 (FR) 12 61479

(51) Int. Cl. C03C 23/00; C03C 17/30; C02F 1/28; B01J 20/02; B01J 20/10; B01J 20/28; B01J 20/30; C03C 15/00; C03C 11/00

(52) U.S. Cl. CPC C03C 23/00; C03C 15/00; C03C 17/30; C02F 1/288; C03C 11/00; B01J 20/103; B01J 20/28092; B01J 20/3078; B01J 20/3071; B01J 20/0229; C03C 2218/31; C02F 2101/006

(57) ABSTRACT

The present invention concerns a method for preparing glass having bimodal macroporous and mesoporous porosity, whereby macroporous glass is subjected to pseudomorphic transformation. The present invention also concerns the said glass thus prepared, optionally functionalised, and the different uses thereof.

### TECHNICAL FIELD

The present invention belongs to the field of porous glass useful in numerous applications such as catalysis, cosmetology, medicine, decontamination, liquid-solid extraction and chemical detection.

More particularly the present invention proposes a method with which it is possible to prepare a glass having bimodal porosity (macroporous and mesoporous porosity) by implementing pseudomorphic transformation. The present invention also concerns the glass with bimodal porosity thus prepared and the uses thereof in particular for catalysis, cosmetology, medicine, decontamination, liquid-solid extraction or chemical detection.

### STATE OF THE PRIOR ART

Liquid-solid extraction is based on the same principle as liquid-liquid extraction with the exception that the molecules which capture the solutes are grafted or adsorbed on a solid phase. The main solid substrates currently used are ion exchange resins and inorganic substrates such as silica, alumina, titanium or zirconium oxides.

These two types of substrate are widely used on industrial scale but have some shortcomings.

Ion exchange resins have reactivity problems (explosion) when used in the presence of nitric acid [1]. Also, when used to trap radioactive elements they may rapidly degrade under the effect of radiolysis [2]. Finally, when used in fluidised beds, their low density gives rise to problems.

Similarly, inorganic substrates in powder form often have a particle size that is too small for use in column separation methods, in particular on account of high head-loss. In addition, although such substrates have large exchange surface areas these are sometimes scarcely accessible.

These problems could be largely improved if the material used exhibited bimodal porosity, namely macroporosity to ensure satisfactory charge transfer and supported mesoporosity on the macroporosity surface to ensure access to a large specific surface area and hence a sufficient fill rate of extracting molecules.

At the present time, the most frequently applied synthesis of oxides having bimodal porosity is based on the phenomenon of spinodal decomposition [3]. This approach has been industrialised for the production of high performance liquid chromatography columns (HPLC), by Merck in particular under the trade name Chromolith®.

Patent application US 2007/065356 describes a method for preparing monolithic porous mouldings from a gelling mould made in particular from glass or fused silica [4]. In this method, the gelling mould is first activated by surface etching and/or by increasing the surface area using tetraalkoxysilanes and/or organoalkoxysilanes and/or by chemical modification using bifunctional silanes or particular alkoxysilanes. The gelling mould thus activated is then filled with a monomer sol comprising silica particles and/or (ceramic) glass fibres and/or organoalkoxysilanes. The monomer sol is then polymerised and the resulting gel is aged for the formation of pores.

However, these syntheses are fairly difficult to control on industrial scale and the resulting monoliths remain high cost. The inventors have set themselves the objective of proposing a method with which it is possible to prepare a material having bimodal porosity that is easy to prepare and economical for industrial application to the preparation of a material for liquid-solid extraction.

In parallel, patent application US 2010/055000 proposes inorganic/organic hybrid totally porous spherical silica particles, these being useful in separation devices [5]. The particles are prepared from porous metal oxide particles (silica, alumina, zirconia or titania) in the presence of one or more surfactants and swelling agents and optionally an organic metal alkoxide, via pseudomorphic transformation. The particles obtained have an ordered arrangement with a narrow median pore size distribution, in particular between 1.5 and 100 nm.

Also the team led by Anne Galarneau recently proposed pseudomorphic synthesis techniques using surfactants allowing stable mesoporous materials to be obtained having a restricted pore size distribution for potential applications in chromatography or catalysis [6-7]. In the work presented by these two articles the starting material is a silica-based amorphous precursor such as silica gel spheres marketed by Merck under the trade name Lichrosphere 100® [6] or the other materials listed in Table 1 of [7].

It is to be noted that pseudomorphic transformation tests performed on glass fibres have not given conclusive results since glass fibres are unable to accommodate the swelling induced by the incorporation of the surfactant used during this pseudomorphic transformation, which translates as bursting of the glass fibres [8].

### DESCRIPTION OF THE INVENTION

The present invention allows the solving of the previously listed technical problems and disadvantages of the materials and methods in the prior art. The inventors have developed a protocol allowing the preparation of a material having bimodal porosity (macroporous and mesoporous) involving a reasonable number of steps and at reasonable cost allowing the envisaged industrial application for said protocol.

More particularly the inventors have chosen to convert a macroporous glass, already successfully used for solid-liquid extraction, to a mesoporous material via pseudomorphic transformation.

From the results obtained by the inventors, it appears that contrary to conventional synthesis routes of mesoporous silica, the pseudomorphic approach does indeed allow organised, controlled porosity to be obtained, but also provides control over the initial macroscopic forming of silica to facilitate the application thereof (for example in catalysis or extraction methods).

While the pseudomorphic approach previously mentioned has already been used with success to prepare mesoporous materials in pure silica, it is fully surprising first that this synthesis is able to be extended to glassmaking compositions and secondly that it can allow the production of a material having bimodal porosity when applied to materials having pre-existing macroporosity. It is surprising in particular in the light of data available up until now regarding the implementation of pseudomorphic synthesis on glassmaking materials [8].

The present invention therefore concerns a method for preparing a glass having bimodal macroporous and mesoporous porosity, which involves subjecting macroporous glass to pseudomorphic transformation.

The definitions given in documents [5-7] regarding pseudomorphic transformation having their origin in mineralogy apply to the present invention. As a result, by <<pseudomorphic transformation>> or <<pseudomorphic synthesis>> is meant a method whereby the starting macroporous glass placed in the presence of a surfactant is partly dissolved on the surface and at depth (in the sense that the inner surface of the material is also partly dissolved) and is immediately re-precipitated both on the surface and at depth in the interstitial spaces of the micelles, whereby pores having the size of the micelles are formed in the glass with a regular pore structure and in some embodiments an ordered structure. The size and morphology of the glass obtained after implementing pseudomorphic transformation are similar to those of the starting glass, the two glass forms essentially differing at pore level with solely the presence of macropores in the starting glass and the presence both of macropores and mesopores in the glass obtained after performing pseudomorphic transformation. The presence of this mesoporosity implies that the glass treated via pseudomorphic route has a much larger specific surface area than the starting glass, which is of particular advantage for the targeted applications.

Any commercial or synthetic macroporous glass can be used in the present invention.

By <<glass>> is meant an amorphous solid having glass transition and composed of silica or silicon oxide (SiO₂) and optionally of one or more other elements, the same or different. As examples of other elements which may be contained in the glass used in the present invention, mention can be made of aluminium, boron, vanadium, phosphorus, calcium, magnesium, sodium, lithium, potassium or one of the mixtures thereof. Glass, in addition to an element such as previously defined, may optionally comprise at least one dopant in particular such as selenium, sulfur, germanium, arsenic, iron, titanium, nickel, zinc, manganese, copper, tin, cobalt, antimony, silver, gold or one of the mixtures thereof.

By <<porous glass>> is meant glass having density lower than the theoretical density of non-porous glass, this difference in density of at least 5% being the result of pores or voids contained in the porous glass. The porosity of the glass can be determined by nitrogen adsorption/desorption measurements or by mercury intrusion porosimetry well known to persons skilled in the art. In particular, the porosity of the macroporous glass used in the invention may range from 5 to 50% and in particular from 10 to 30% by volume relative to the total volume of the glass.

By <<macroporous glass>> is meant glass of which the pores or voids are mostly macropores. By <<macropores>> are meant pores or voids having a mean diameter larger than 50 nm and in particular larger than 70 nm. Advantageously, the macroporous glass used in the present invention comprises less than 10% and in particular less than 5% of mesopores and/or micropores, said percentage being expressed in volume relative to the volume of the total porosity of the glass.

In a 1^{st} variant, the macroporous glass used in the present invention comprises neither micropores nor mesopores or, if it does contain the same, these micropores or mesopores are contained in negligible quantity in relation to the macropores of this glass. By <<negligible quantity>> is meant less than 1% and in particular less than 0.1% of mesopores and/or micropores, said percentage being expressed in volume relative to the volume of the total porosity of the glass.

In a 2^{nd} variant, the macroporous glass used in the present invention has macropores and to a lesser extent mesopores. By <<lesser quantity>> is meant a quantity of mesopores and/or micropores of between 1% and 10%, said percentage being expressed in volume relative to the volume of the total porosity of the glass. The implementing of a method of the invention i.e. pseudomorphic treatment allows an increase to be obtained in the mesoporosity of the treated glass having bimodal porosity when compared with the starting glass and optionally allows reorganisation of this mesoporosity in particular when the mesoporosity of the starting glass is ill-defined.

In the macroporous glass used in the present invention, the macropores are advantageously regularly distributed throughout the glass. In the macroporous glass used in the present invention the macropores can be linked together or isolated from one another. Advantageously, the macroporous glass used in the present invention has open porosity i.e. most of the macropores of this glass are linked together.

The macroporous glass used in the present invention may be of varied size and shape. It may be in the form of beads, particles, microparticles, nanoparticles, fibres, monoliths, tubes or sheets. Persons skilled in the art will be able to determine the size and shape best adapted in relation to the envisaged application for the prepared mesoporous and macroporous glass. In one particular embodiment the macroporous glass used is in the form of particles of powder type having a controlled particle size of between 1 μm and 10 mm and in particular between 10 μm and 1 mm. In this particular embodiment, the macroporous glass has a BET specific surface area of between 5 and 500 m²/g and in particular between 10 and 50 m²/g.

The macroporous glass used in the present invention may be commercial macroporous glass or a macroporous glass prepared before implementing the method of the invention, using any technique known to those skilled in the art and in particular the use of one of more pore-forming agent(s), of one of more acid and/or base chemical attack(s) and/or one or more heat treatment(s). Advantageously the macroporosity of the glass used in the present invention is the result of controlled demixing followed by chemical attack.

As previously explained, the glass having bimodal macroporous and mesoporous porosity prepared following the method of the invention displays macroporosity correspond to that of the starting macroporous glassmaking material i.e. it has pores with a mean diameter larger than 50 nm and in particular larger than 70 nm, and has mesoporosity resulting from implementation of the method. Therefore the glass with bimodal porosity has mesopores having a mean diameter of between 2 and 50 nm and in particular between 2 and 20 nm. Advantageously, the mesopores of the material with bimodal porosity obtained by implementing the method of the invention are located in the layer on the surface (i.e. at the wall) of the macropores.

More specifically the method of the present invention comprises the following steps of:

a) preparing an alkaline solution comprising at least one surfactant and said macroporous glass;

b) subjecting the solution prepared at step (a) to heat treatment allowing the pseudomorphic transformation of said macroporous material;

c) recovering the treated glass obtained at step (b) and making accessible the bimodal mesoporous and macroporous porosity of said glass.

Step (a) of the method of the invention therefore entails preparing an alkaline solution containing at least one surfactant and the macroporous glass.

By <<alkaline solution>> is meant a solution having a pH higher than 10, in particular higher than 11 and, more particularly higher than 12. The solution of step (a) is preferably buffered at a basic pH generally higher than 10, in particular higher than 11 and more particularly higher than 12. The base used to form this solution can be selected from among different salts such as sodium hydroxide, sodium carbonate, lithium hydroxide, lithium carbonate, potassium hydroxide, potassium carbonate, ammonium hydroxide, ammonium carbonate or one of the mixtures thereof.

The choice of concentration of the base and of the volume of solution at step (a) is a function of the quantity of glass to be treated. Persons skilled in the art are able to determine a pertinent choice taking into account the previously mentioned criterion of pH and the principle that under no circumstances must this choice lead to complete dissolution of the glass. For this purpose, the Base/SiO₂ molar ratio is advantageously lower than 4, in particular lower than 1 and more particularly lower than 0.5.

As an example, sodium hydroxide can be contained in the solution of step (a) in an amount of between 10 mM and 5 M, in particular between 0.1 M and 1 M and more particularly of around 0.7 M (i.e. 0.7 M±0.1 M).

The solvent of the alkaline solution prepared at step (a) is advantageously water optionally in a mixture with a simple alcohol such as methanol, ethanol or one of the mixtures thereof. The water used may be mains water, deionised water, distilled water, whether or not basic.

By <<surfactant>> is meant a molecule comprising a lipophilic part (apolar) and a hydrophilic part (polar). Advantageously, said at least one surfactant contained in the solution prepared at step (a) of the method of the invention is selected from among anionic surfactants, cationic surfactants, zwitterionic surfactants, amphoteric surfactants and non-ionic surfactants. The solution prepared at step (a) of the method may comprise several surfactants belonging to one same family of surfactants as previously listed (i.e. anionic, cationic, zwitterionic or amphoteric) or several surfactants belonging to at least two of these different families of surfactants.

It is recalled that anionic surfactants are surfactants of which the hydrophilic part is negatively charged such has alkyl or aryl sulfonates, sulfates, phosphates or sulfosuccinates associated with a counter ion such as an ammonium ion (NH₄⁺), a quaternary ammonium such as tetrabutylammonium, and alkaline cations such as Na⁺, Li⁺ and K⁺. As anionic surfactant it is possible for example to use tetraethylammonium paratoluenesulfonate, sodium dodecylsulfate, sodium palmitate, sodium stearate, sodium myristate, sodium di(2-ethylhexyl) sulfosuccinate, methylbenzene sulfonate and ethylbenzene sulfonate.

Cationic surfactants are surfactants of which the hydrophilic part is positively charged, selected in particular from among quaternary ammoniums having at least one C₄-C₂₂ aliphatic chain and associated with an anionic counter ion selected from among derivatives of boron such as tetrafluoroborate or halide ions such as F⁻, Br⁻, I⁻ or Cl⁻ ions. As cationic surfactant it is possible for example to use tetrabutyl-ammonium chloride, tetradecyl-ammonium chloride, tetradecyl-trimethyl-ammonium bromide (TTAB), cetyl-trimethyl-ammonium bromide (CTAB), octadecyl-trimethyl-ammonium bromide, hexadecyl-trimethyl-ammonium bromide, the halides of alkylpyridinium carrying an aliphatic chain and the halides of alkylammonium.

Zwitterionic surfactants are neutral compounds having formal electric charges of one unit and of opposite signs, selected in particular from among compounds having a C₅-C₂₀ alkyl chain generally substituted by a negatively charged function such as a sulfate or carboxylate and a positively charged function such as an ammonium. As examples of zwitterionic surfactants mention can be made of sodium N,N dimethyl-dodecyl-ammoniumbutanate, sodium dimethyl-dodecyl-ammonium propanate and amino acids.

Amphoteric surfactants are compounds which can behave either as an acid or as a base depending on the medium in which they are placed. As amphoteric surfactant it is possible to use disodium lauroamphodiacetate and betaines such as alkylamidopropylbetaine or laurylhydroxysulfobetaine.

Non-ionic (or neutral) surfactants are compounds of which the surfactant properties, hydrophilicity in particular, are provided by non-charged functional groups such as an alcohol, ether, ester or an amide, containing heteroatoms such as nitrogen or oxygen. On account of the low hydrophilic contribution of these functions, non-ionic surfactant compounds are most often multifunctional. As non-ionic surfactant it is possible to use polyethers such as polyethoxylated surfactants e.g. polyethyleneglycol laurylether (POE23 ou Brij® 35), polyols (sugar-derived surfactants) in particular glucose alkylates such as glucose hexanate or block copolymers such as the pluronic F127®.

In the present invention, the surfactant(s) used are advantageously selected from among anionic surfactants and cationic surfactants and more particularly from among cationic surfactants.

The surfactant(s) used at step (a) are contained in the solution of step (a) in a weight ratio relative to the total weight of the solution of between 0.1% and 90%, in particular between 1 and 50% and more particularly in the order of 10% (i.e. 10%±5%).

Finally, the macroporous glass such as previously defined is contained in the solution prepared at step (a) of the method of the invention in an amount of between 10 and 600 g/L of solution, in particular between 50 and 400 g/L of solution and more particularly between 100 and 200 g/L of solution.

Several variants can be envisaged at step (a) of the method of the invention. It is possible:

a₁) to prepare the solution of step (a) by mixing together the different elements it contains optionally followed by modifying the pH to make the solution alkaline;

a₂) to prepare a first solution containing at least one surfactant, optionally to modify the pH thereof to make it alkaline and then add thereto the macroporous glass and optionally modify the pH of the solution thus obtained to make it alkaline; or

a₃) to prepare a first solution comprising the macroporous glass and optionally modify the pH thereof to make it alkaline, then to add at least one surfactant and optionally modify the pH of the solution thus obtained to make it alkaline.

Advantageously, at step (a) of the method of the invention a first solution is previously prepared containing at least one surfactant and the pH thereof is optionally modified to make it alkaline, after which the macroporous glass is added and the pH of the solution obtained is optionally modified to make it alkaline (above variant (a₂)). More particularly, at step (a) of the method of the invention a first solution is previously prepared, hereinafter called solution (S₁) comprising at least one surfactant, the pH of this first solution is modified to make it alkaline and the macroporous glass is then added.

Advantageously the solution (S₁), like the solution prepared at step (a), has water as solvent optionally in a mixture with a simple alcohol such as methanol, ethanol or one of the mixtures thereof. The water used may be tap water, deionised water, distilled water, whether acidified or basic. Therefore solution (S₁) is an aqueous solution comprising one or more (different) surfactant(s).

The surfactant(s) can be added to the solution (S₁) in solid form or in liquid form. When several different surfactants are used they can be mixed at once or they can be added one after the other or in groups. The mixing and optional dissolution of the surfactant(s) in the solution (S₁) are conducted under agitation using an agitator, magnetic stir bar, ultrasound bath or homogenizer, and can be performed at a temperature of between 10 and 40° C., advantageously between 15 and 30° C. and more particularly at ambient temperature (i.e. 23° C.±5° C.) for a time of between 5 min and 2 h, in particular between 15 min and 1 h, and more particularly of around 30 min (i.e. 30 min±10 min).

Once this 1^{st} mixing has been carried out, the salt(s) used to modify the pH of the solution (S₁) and to make it alkaline are added to this solution in solid form or liquid form in an adequate amount. If several different salts are used they can be added to the solution (S₁) in a single time or they can be added one after the other or in groups. The resulting solution is mixed to homogeneity. This 2^{nd} mixing step is performed using an agitator, magnetic stir bar, ultrasound bath or homogenizer and can be performed at a temperature of between 10 et 40° C., advantageously between 15 and 30° C. and more particularly at ambient temperature (i.e. 23° C.±5° C.) for a time of between 15 s and 15 min and in particular between 30 s and 5 min. The macroporous glass is then added to the resulting alkaline solution containing at least one surfactant whereby the solution of step (a) is prepared. An additional mixing step identical to one of the two mixing steps previously described can also be envisaged after the adding of the macroporous glass.

At step (b) of the method of the invention the alkaline solution prepared at step (a) i.e. containing at least one surfactant and the macroporous glass is subjected to pseudomorphic synthesis.

For this purpose, the alkaline solution prepared at step (a) is subjected to heat treatment at a temperature of 60° C. or higher, in particular at a temperature of between 70° C. and 160° C., more particularly at a temperature of between 80° C. and 130° C. and further particularly at a temperature of around 100° C. (i.e. 100° C.±15° C.).

It is within the reach of persons skilled in the art to determine the duration of step (b) of the method of the invention, in particular as a function of the other parameters of pseudomorphic synthesis such as reaction temperature and concentration of base. Step (b) of the method of the invention is advantageously implemented in an autoclave or under reflux for a time of longer than 15 min, in particular between 30 min and 10 h, more particularly between 1 h and 5 h and further particularly of around 3 h (i.e. 3 h±1 h particularly 3 h±30 min).

In addition, step (b) of the method of the invention can be performed under agitation using an agitator, magnetic stir bar, ultrasound bath or homogenizer.

Any technique allowing the recovery of the bimodal macroporous and mesoporous glass obtained at step (b) can be used at step (c) of the method of the invention. Advantageously this step (c) is intended first to separate the bimodal porosity glass from the solution used at steps (a) and (b), and secondly to remove the surfactant(s) associated with such glass. Therefore step (c) of the method of the invention uses one or more step(s), the same or different, selected from among steps of filtration, centrifugation, sedimentation, calcining, drying and washing. In one particular embodiment step (c) of the method of the invention comprises at least one filtration step, at least one washing step, at least one drying step and at least one calcining step.

The filtration step(s) is/are performed in vacuo and in particular using apparatus of Büchner type optionally with cellulose membranes, Teflon membranes or pleated crepe paper filters having a filtering threshold selected in relation to the size of the macroporous glass initially used. This filtering threshold may be in nm range or μm range.

The washing step(s) are performed in a polar solvent. When the recovery step entails several washings one same polar solvent is used for several and even for all the washings, or several different polar solvents are used for each washing. By <<polar solvent>> in the present invention is meant a solvent selected from the group consisting of water, deionised water, distilled water, whether acidified or basic, acetic acid, hydroxylated solvents such as methanol and ethanol, liquid glycols of low molecular weight such as ethyleneglycol, dimethylsulfoxide (DMSO), acetonitrile, acetone, tetrahydrofuran (THF) and the mixtures thereof. Advantageously the polar solvent used at the washing step(s) is acetone.

The drying step(s) can be conducted in a heating or drying oven at a temperature of between 50° C. and 150° C., in particular between 60° C. and 130° C. and in particular at a temperature of around 80° C. (80° C.±10° C.) and typically for a time of between 30 h and 15 d, in particular between 3 d and 10 d and more particularly for 1 week.

The calcining step(s) can be conducted in air or ozone at a temperature of 500° C. or lower, in particular at a temperature of between 300° C. and 480° C., more particularly between 350° C. and 450° C. and further particularly at a temperature of around 400° C. (i.e. 400° C.±20° C.) and typically for a time of between 1 h and 10 h, in particular between 2 h and 7 h and more particularly for a time of about 4 h (i.e. 4 h±30 min).

The present invention also concerns a method for removing, retaining, immobilising or isolating a compound contained in a fluid using the glass having bimodal porosity prepared in conformity with the above-described method.

More particularly, the present invention concerns a method for immobilising at least one compound possibly contained in a fluid, this method comprising the steps of:
i) preparing a glass having bimodal macroporous and mesoporous porosity using a method such as previously defined;
ii) optionally functionalising the glass prepared at step (ii); and
iii) contacting said fluid with the optionally functionalised, glass having bimodal macroporous and mesoporous porosity, whereby said compound if present is immobilised on and/or in said glass.

In the present invention by <<compound>> is meant both an undesired compound such as a pollutant or contaminant and a compound of interest (pharmaceutical, cosmetic or industrial . . . ) which may be or is contained in a fluid.

The compound may be an organic or inorganic compound, and may or may not carry one or more molecular or particle loads. The compound may be of biological origin or chemical origin. Said compound may be contained in the fluid in dissolved form, in colloid form, in the form of aggregates of materials in particular organic materials, or in the form of complexes in particular anionic or cationic complexes.

Thus, the compound can be selected from among NO₂, CO, a phenol, an insecticide, a pesticide, a volatile organic compound such as an aldehyde, formaldehyde, acetaldehyde, naphthalene, a primary amine in particular aromatic, indole, skatole, tryptophan, urobilinogen, pyrrole, benzene, ethylbenzene, toluene, xylene, styrene, naphthalene, halogenated compound, a radionuclide, a metal or radioactive isotope of said metal, a molecule of biological interest, a molecule of pharmacological interest, a toxin, a carbohydrate, a peptide, a protein, a glycoprotein, an enzyme, an enzymatic substrate, an hormone, a polyclonal or monoclonal antibody, an antibody fragment, a nucleotide molecule, an advantageously organic pollutant of water or air, a bacterium and a virus.

The compound may be contained in the fluid in highly dilute form or much more concentrated. Thus, the quantity of said compound in the fluid is between 1 μg and 100 g/litre of fluid.

In the present invention, by <<fluid>> is meant a gas or liquid. More particularly said fluid can be selected from among a biological fluid; a sample of culture medium or sample from a biological culture reactor such as a cell culture of higher eukaryotes, yeasts, fungi or algae; a liquid obtained from one or more animal or plant cell(s); a liquid obtained from animal or plant tissue; a food matrix sample; a sample from a chemical reactor; tap water, river water, pond water, lake water, seawater, aquarium water, cooling water in air-conditioning systems or cooling towers; a product in particular a liquid product, an effluent or wastewater derived from intensive farming or industries or installations in the chemical, pharmaceutical, cosmetic or nuclear fields; a pharmaceutical product; a cosmetic product; a perfume; or one of the mixtures thereof. More generally, the present invention concerns a device and a method which can be applied to any gaseous or liquid fluid from or in which at least one compound is to be extracted or detected.

The biological fluid is advantageously any fluid naturally secreted or excreted by a plant or human or animal body, or any fluid collected from a plant or human or animal body using any technique known to persons skilled in the art such as extraction, sampling or washing. The collection and isolating steps of these different fluids from the human or animal body are performed prior to implementing the method of the invention.

All the embodiments and variants described for the method to prepare a bimodal macroporous and mesoporous glass according to the invention also apply to step (i) of the method of the invention.

Step (ii) is optional and can be performed to increase the affinity of the glass with bimodal porosity for the compound to be immobilised, compared with the affinity of the glass with bimodal porosity without functionalization. By <<functionalising the glass having bimodal porosity>> is therefore meant the application of a chemical protocol for the direct or indirect covalent grafting of a reagent on the surface of the glass with bimodal macroporous and mesoporous porosity, and in particular on the surface inside the pores of the glass.

The reagent used to functionalise the bimodal porosity glass used in the present invention is capable of forming a bonding pair with the compound to be immobilised, this reagent and the compound corresponding to the two partners of this bonding pair. The bonds involved in the compound-reagent bonding are either non-covalent bonds of low energy such as hydrogen bonds or Van der Waals bonds, or high energy bonds of covalent bonding type. Therefore the fixing or immobilisation of the compound in and/or on the glass and in particular inside the pores of the bimodal porosity glass, at step (iii) of the method of the invention involves bonds which may be non-covalent bonds of low energy and/or bonds of high energy.

The reagent used is therefore dependent on the compound to be immobilised. In relation to this analyte persons skilled in the art, without displaying any inventiveness, are able to select the reagent that is best adapted. This reagent can be selected from the group consisting of a chemical group able to form a bonding pair with the compound or a molecule carrying at least one chemical group able to form a bonding pair with the compound. The molecule carrying at least one chemical group able to form a bonding pair with the compound may be complex of polymer type. More particularly, this reagent is selected from the group consisting of hydroxyl, thiol, azide, epoxide, aziridine, amine, phosphine, phosphonate, phosphine oxide, oxime amide, carbamate, nitrile, isocyanate, thiocyanate, nitro, amide, halide in particular alkyl halide, carboxylic acid and ester functions; a molecular probe; a carbohydrate; a peptide; a protein; a glycoprotein; an enzyme; an enzymatic substrate; a toxin; a polyclonal or monoclonal antibody; an antibody fragment; a nucleotide molecule; a peptide nucleic acid and an aptamer such as a DNA aptamer or RNA aptamer and a (nano)particle of ferrocyanide.

The reagent can be attached or grafted, covalently whether directly or indirectly, on the surface of the glass having macroporous and mesoporous bimodal porosity and in particular on the surface inside the pores of this glass. If attachment is direct, a covalent bond links one atom of the reagent to one atom of the glass. On the contrary if it is indirect, attachment uses a linker arm (or spacer arm or junction agent or linking agent) that is generally organic, this arm having a 1^{st} atom involved in a covalent bond with a glass atom and a 2^{nd} atom, different from the 1^{st} one, involved in a covalent bond with an atom of the reagent. As examples of linker arms mention can be made of -(PEG)ₙ- and —(CH₂)ₙ— where n is an integer from 1 to 20 and PEG is a polyethylene glycol repeating unit.

Functionalization at step (ii) of the method of the invention benefits from the presence of silanol groups on the surface of the glass with bimodal porosity and can entail silanization reactions using alkoxysilanes. The experimental section below gives two examples of functionalization inspired in particular from documents [9-10]. It is known to those skilled in the art which other different protocols can be used to functionalise the surface of the glass having bimodal porosity, and in particular the surface inside the pores contained in this glass.

The contacting at step (iii) can be implemented in different manners in relation to the gaseous or liquid nature of the fluid in which the compound to be immobilised may be contained. Different variants can be used for the contacting at step (iii) of the method of the invention. For example, it is possible to immerse the glass of the invention in the liquid fluid, to deposit a certain volume of liquid fluid on said glass, to place said glass in the presence of the gaseous fluid (static exposure) or to circulate the fluid and in particular gaseous fluid over said glass (dynamic exposure).

In some of these variants, it may be advantageous to pack the glass having bimodal porosity of the invention in the form of a column in particular in which the glass of the invention corresponds to a fluidised bed for which the liquid or gaseous fluid ensures fluidisation.

If the glass is immersed in the liquid fluid, it may be advantageous to agitate the mixture thus obtained and then to recover the glass using any of the recovery methods previously envisaged after a certain contact time.

The contact time between the fluid and the glass having bimodal porosity of the invention is variable and may range from 1 min to 3 d, and in particular from 5 min to 24 h and more particularly from 10 min to 12 h.

The present invention also concerns glass having bimodal macroporous and mesoporous porosity, able to be prepared using a preparation method such as previously defined, but also functionalised glass having bimodal macroporous and mesoporous porosity able to be obtained after step (ii) of the immobilisation method such as previously defined.

As previously explained, the glass of the invention has macropores with a mean diameter larger than 50 nm and in particular larger than 70 nm, and mesopores with a mean diameter of between 2 and 50 nm and in particular between 2 and 20 nm. Advantageously, the mesopores of the glass of the invention are located in the layer on the surface (i.e. at the wall) of the macropores. The functionalised glass of the invention additionally has reagents such as previously defined covalently bonded either directly or indirectly on the surface of the glass and in particular on the inner surface of the mesopores and/or macropores of this glass.

The glass having bimodal porosity according to the invention differs with regard to the pores from the starting material namely the macroporous glass. This difference leads to differences regarding the specific surface area of the bimodal porosity glass of the invention that has a specific surface area at least twice greater and in particular at least five times greater and more particularly at least ten times greater than the specific surface area of the starting macroporous glass.

Therefore, as explained in [7], through the fact that the glass having bimodal porosity of the invention has a high specific surface area, a large pore volume and mesopores, it improves the retaining capacity, the permeability of chromatography columns and molecular selectivity in separation methods.

Finally, the present invention concerns different uses of such glass which finds applications in most varied fields such as the decontamination field, the microbiology field, the field of diagnosis or medical treatment, the nuclear field, the quality control field, the agri-food field, the screening of unlawful substances, the defence and/or biodefence sector, the field of veterinary, environmental and/or health inspection and/or in the field of perfumes, cosmetics and/or flavourings.

As more particular examples, particular mention can be made of the use of the glass of the invention in the fields of catalysis, chemical detectors and chromatography.

In the field of catalysis, molecular catalysts such as molecular catalysts containing platinum, ruthenium, iridium or metal oxides are immobilised on glass having bimodal porosity of the invention, whether or not functionalised, by implementing the immobilisation method such as previously defined.

Glass having bimodal porosity according to the present invention, whether or not functionalised, is also useful as stationary phase for chromatography and in particular for gas chromatography, thin layer chromatography, affinity chromatography, capillary column gas chromatography, size exclusion chromatography, high performance liquid chromatography (HPLC), chiral HPLC, reverse phase HPLC (RP-HPLC) and protein separation by RP-HPLC.

In the field of chemical detectors the glass having bimodal porosity according to the present invention, whether or not functionalised, acts as detector and to do so it may be advantageous to functionalise this glass using a reagent adapted to the compound to be detected.

The glass of the invention, as a variant, can be used in the decontamination field and in particular for nuclear decontamination or radiological decontamination. For this purpose glass having bimodal porosity according to the invention, whether or not functionalised, is used in the immobilisation method of the invention to immobilise pollutants and contaminants contained in a fluid to be decontaminated and in particular in a fluid or effluent derived from the nuclear industry or nuclear plants or from an industry, laboratory, hospital, clinic or installation using radionuclides. In this case, the compound to be immobilised on the glass of the invention is a radionuclide such as a radioactive isotope of caesium, strontium, cobalt, silver, ruthenium, iron or thallium.

One last use of the glass having bimodal porosity according to the invention, whether or not functionalised, belongs to the therapeutic field or cosmetic field. For such use, a compound having preventive or curative therapeutic action or cosmetic effect action of hydrating, slimming, anti-UV type . . . is immobilised on the glass having bimodal porosity of the invention whether or not functionalised. When applied to the skin the latter, in relation to its size, either remain on the surface of the skin or enter into the dermis and in both cases the release of the compound having therapeutic action or cosmetic action can be obtained. Therefore the present invention concerns glass having bimodal porosity according to the present invention whether or not functionalised for use in the medical field.

Other characteristics and advantages of the present invention will become further apparent to persons skilled in the art on reading the non-limiting examples given below for illustration purposes with reference to the appended Figures.

### BRIEF DESCRIPTION OF THE DRAWINGS

FIG. 1 illustrates the volume V₀ of adsorbed nitrogen expressed in cm³/g as a function of P/P₀ where P is the partial pressure of nitrogen and P₀ the maximum adsorbed pressure when measuring porosity using BET apparatus.

FIG. 2 gives scanning electron microscope images (SEM) of the initial macroporous glass (FIG. 2A) and of the material having bimodal porosity obtained by pseudomorphic synthesis but of which only the macroporosity can be seen under SEM (FIG. 2B).

### DETAILED DESCRIPTION OF PARTICULAR EMBODIMENTS

I. Pseudomorphic Synthesis on Glass of Vycor® Type.

Glass of Vycor® type supplied by VitraBio Trisopor having a pore size of 105 nm and specific surface area of 16 m²·g⁻¹.

The synthesis of pseudomorphic glass is inspired from publication [6].

Typically, 1.2 g of cetyl-trimethyl-ammonium bromide (CTAB) are dissolved in 11.9 ml of water, under agitation for 30 min, then 0.33 g of NaOH are added to the mixture and the mixture left under agitation until the mixture is homogeneous. In an autoclave, 2 g of porous glass having a pore size of 105 nm are added to the preceding solution and the whole is placed at 100° C. for 3 h.

The product is filtered on Büchner apparatus, washed with acetone, dried at 80° C. overnight and finally calcined at 400° C. for 4 h. The solid obtained has a specific surface area of 200 m²·g⁻¹ (to be compared with the 16 m²·g⁻¹ of the starting glass).

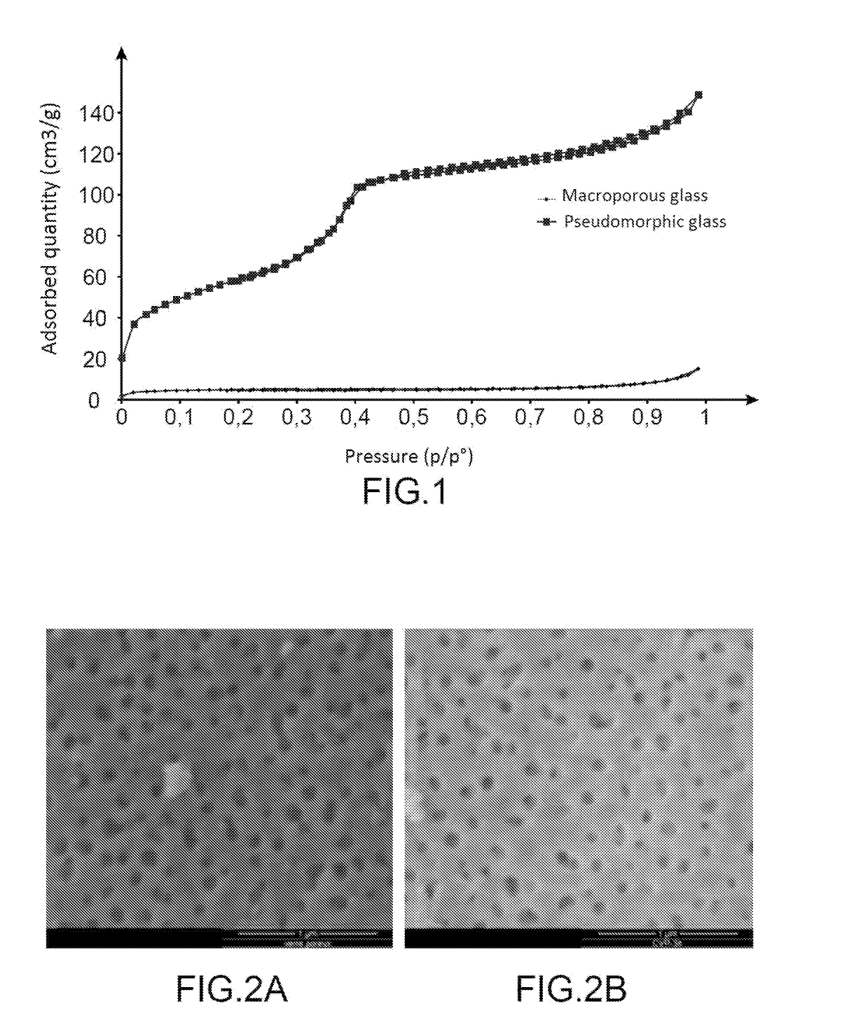

The porosity of the material is divided into two families of pores. One is formed of mesopores centred around 4 nm, as shown by the nitrogen adsorption measurements (FIG. 1). The other is formed of macropores centred around 100 nm as shown by the scanning electron microscope images (FIG. 2B). This second family of pores corresponds to the one already contained in the starting material (FIG. 2A).

II. Application to Gold.

The pseudomorphic glass synthesised under item I was grafted by silanization reaction. In the conventional grafting method on silica, a complexing molecule linked to a siloxane group is reacted on the silanol group of the glass.

The choice of grafted molecule was influenced by the targeted application, here the extraction of gold from an aqueous solution. Since thiols have good affinity for heavy metals [9], the inventors chose to graft (3-mercaptopropyl)trimethoxysilane. After grafting, the solid obtained exhibited a theoretical exchange capacity of 0.5 milliequivalents per gram.

A solution of gold at 2 mM concentration was prepared. The inventors placed about 200 mg of grafted pseudomorphic glass in contact with 50 mL of this gold solution under agitation overnight.

To analyse the results obtained, for the application to gold, the inventors used UV-visible analysis to determine the concentration of gold remaining in the water, this concentration being less than 0.05 mM. With this grafted pseudomorphic glass, the gold extraction obtained was therefore higher than 99%.

III. Application to Caesium.

Recently, the use of nanoparticles of ferrocyanide grafted on a porous glass substrate of Vycor® type was described for the extraction of caesium in solution [10]. This same synthesis was used to graft such nanoparticles on the glass having bimodal porosity synthesised under item I.

A batch caesium sorption test was conducted on the glass obtained having bimodal porosity and grafted with the ferrocyanide nanoparticles. For this purpose, 10 mg of glass were placed in contact for 24 h with 20 ml of caesium nitrate solution (CsNO₃). The solutions were filtered and analysed before and after caesium absorption by ion chromatography. The initial and final concentrations obtained for the pseudomorphic glass with grafted ferrocyanide particles were respectively 14.9 ppm and 5.7 ppm. The amount of extracted caesium per gram of pseudomorphic glass grafted with ferrocyanide nanoparticles was 0.14 mmol/g.

The same test was performed on the parent glass of the pseudomorphic glass with grafted ferrocyanide nanoparticles i.e. the macroporous glass having a specific surface area of 16 m²·g⁻¹ and a pore diameter of 105 nm. On this sample the same grafting protocol was performed (grafting of nanoparticles of cobalt hexacyanoferrate) and the same caesium extraction test using CsNO₃ in 20 mL of solution per 10 mg of solid. The measured initial and final concentrations were respectively the following: 14.9 ppm and 10.5 ppm, which corresponds to an extraction capacity of 0.07 mmol/g i.e. two times less efficient than the same glass subjected to pseudomorphic transformation.

### REFERENCES

[1] Calmon, C., 1980, <<Explosion hazards of using nitric acid in ion-exchange equipment>>, Chemical Engineering, vol. 87, pages 271-274.
[2] Pillay, K. K. S, 1986, <<A review of the radiation stability of ion exchange materials>>, Journal of Radioanalytical and Nuclear Chemistry, vol. 102, no 1, pages 247-268.
[3] Nakanishi K., 1991, <<Phase separation in gelling silica-organic polymer solution: systems containing poly(sodium styrenesulfonate)>>, Journal of the American Ceramic Society, vol. 74, pages 2518-2530.
[4] Patent application US 2007/065356 by Cabrera and Knoell published on 22 Mar. 2007.
[5] Patent application US 2010/055000 by Agilent Technologies Inc. published on 4 Mar. 2010.
[6] Martin et al., 2002, <<Morphological control of MCM-41 by pseudomorphic synthesis>>, Angewandte Chemie International Edition, vol. 41, no 14, 2590-2592.
[7] Galarneau et al., 2006, <<Controlling the Morphology of Mesostructured Silicas by Pseudomorphic Transformation: a Route Towards Applications>>, Advanced Functional Materials, vol. 16, no 13, 1657-1667.
[8] Ph.D. thesis by Frederic Goettmann, <<Matériaux hybrides mésoporeux en catalyse: du matériau support au système catalytique>>, presented on 21 Sep. 2005, pages 129-133.
[9] Liu et al., 2000, <<A new class of hybrid materials with functionalized organic monolayers for selective adsorption of heavy metal ions>>, Chemical Communications, vol. 15, no 13, pages 1145-1146.
[10] International application WO 2010/133689 by CEA, CNRS and Université de Montpellier, published on 25 Nov. 2010.

1-17. (canceled)

18. A method for preparing a glass having bimodal macroporous and mesoporous porosity, comprising:
subjecting a macroporous glass to pseudomorphic transformation.

19. The method according to claim 18, further comprising the steps of:
a) preparing an alkaline solution comprising at least one surfactant and said macroporous glass;
b) subjecting the solution prepared at step (a) to heat treatment allowing the pseudomorphic transformation of said macroporous material; and
c) recovering the treated glass obtained at step (b) and making accessible the bimodal mesoporous and macroporous porosity of said glass.

20. The method according to claim 19, wherein said alkaline solution has a pH higher than 10.

21. The method according to claim 20, wherein said alkaline solution has a pH higher than 11.

22. The method according to claim 21, wherein said alkaline solution has a pH higher than 12.

23. The method according to claim 19, wherein said alkaline solution the Base/SiO₂ molar ratio is lower than 4.

24. The method according to claim 23, wherein said alkaline solution the Base/SiO₂ molar ratio is lower than 1.

25. The method according to claim 24, wherein said alkaline solution the Base/SiO₂ molar ratio is lower than 0.5.

26. The method according to claim 19, wherein said surfactant is selected from among anionic surfactants, cationic surfactants, zwitterionic surfactants, amphoteric surfactants, and non-ionic surfactants.

27. The method according to claim 19, wherein said step (a) comprises:
previously preparing a first solution comprising at least one surfactant;
modifying the pH of this first solution so that it becomes alkaline; and
then adding the macroporous glass thereto.

28. The method according to claim 19, wherein at step (b) the alkaline solution prepared at step (a) is subjected to heat treatment at a temperature of 60° C. for a time of more than 5 minutes.

29. The method according to claim 28, wherein at step (b) the alkaline solution prepared at step (a) is subjected to heat treatment at a temperature of 60° C. for a time of between 30 minutes and 10 hours.

30. The method according to claim 29, wherein at step (b) the alkaline solution prepared at step (a) is subjected to heat treatment at a temperature of 60° C. for a time of between 1 hour and 5 hours.

31. The method according to claim 30, wherein at step (b) the alkaline solution prepared at step (a) is subjected to heat treatment at a temperature of 60° C. for a time of around 3 hours±1 hour.

32. The method according to claim 31, wherein at step (b) the alkaline solution prepared at step (a) is subjected to heat treatment at a temperature of 60° C. for a time of between 3 hours±30 min.

33. The method according to claim 19, wherein at step (b) the alkaline solution prepared at step (a) is subjected to heat treatment at a temperature of between 70° C. and 160° C. for a time of more than 5 minutes.

34. The method according to claim 33, wherein at step (b) the alkaline solution prepared at step (a) is subjected to heat treatment at a temperature of between 70° C. and 160° C. for a time of between 30 minutes and 10 hours.

35. The method according to claim 34, wherein at step (b) the alkaline solution prepared at step (a) is subjected to heat treatment at a temperature of between 70° C. and 160° C. for a time of between 1 hour and 5 hours.

36. The method according to claim 35, wherein at step (b) the alkaline solution prepared at step (a) is subjected to heat treatment at a temperature of between 70° C. and 160° C. for a time of around 3 hours±1 hour.

37. The method according to claim 36, wherein at step (b) the alkaline solution prepared at step (a) is subjected to heat treatment at a temperature of between 70° C. and 160° C. for a time of between 3 hours±30 min.

38. The method according to claim 19, wherein at step (b) the alkaline solution prepared at step (a) is subjected to heat treatment at a temperature of between 80° C. and 130° C. for a time of more than 5 minutes.

39. The method according to claim 38, wherein at step (b) the alkaline solution prepared at step (a) is subjected to heat treatment at a temperature of between 80° C. and 130° C. for a time of between 30 minutes and 10 hours.

40. The method according to claim 39, wherein at step (b) the alkaline solution prepared at step (a) is subjected to heat treatment at a temperature of between 80° C. and 130° C. for a time of between 1 hour and 5 hours.

41. The method according to claim 40, wherein at step (b) the alkaline solution prepared at step (a) is subjected to heat treatment at a temperature of between 80° C. and 130° C. for a time of around 3 hours±1 hour.

42. The method according to claim 41, wherein at step (b) the alkaline solution prepared at step (a) is subjected to heat treatment at a temperature of between 80° C. and 130° C. for a time of between 3 hours±30 min.

43. The method according to claim 19, wherein at step (b) the alkaline solution prepared at step (a) is subjected to heat treatment at a temperature of around 100° C. (i.e. 100° C.±15° C.) for a time of more than 5 minutes.

44. The method according to claim 43, wherein at step (b) the alkaline solution prepared at step (a) is subjected to heat treatment at a temperature of around 100° C. (i.e. 100° C.±15° C.) for a time of between 30 minutes and 10 hours.

45. The method according to claim 44, wherein at step (b) the alkaline solution prepared at step (a) is subjected to heat treatment at a temperature of around 100° C. (i.e. 100° C.±15° C.) for a time of between 1 hour and 5 hours.

46. The method according to claim 45, wherein at step (b) the alkaline solution prepared at step (a) is subjected to heat treatment at a temperature of around 100° C. (i.e. 100° C.±15° C.) for a time of around 3 hours±1 hour.

47. The method according to claim 46, wherein at step (b) the alkaline solution prepared at step (a) is subjected to heat treatment at a temperature of around 100° C. (i.e. 100° C.±15° C.) for a time of between 3 hours±30 min.

48. The method according to claim 19, wherein said step (c) applies one or more steps, the same or different, selected from among the steps of filtration, centrifugation, sedimentation, calcining, drying, and washing.

49. A method for immobilising at least compound which may be contained in a fluid, the method comprising the steps of:
i) preparing a glass having bimodal macroporous and mesoporous porosity such as defined in claim 18;
ii) functionalising the glass prepared at step (i); and
iii) contacting said fluid with the functionalised glass having bimodal macroporous and mesoporous porosity, whereby said at least one compound is immobilised on and/or in said glass.

50. The method according to claim 49, wherein said compound is selected from among NO₂, CO, a phenol, an insecticide, a pesticide, a volatile organic compound such as an aldehyde, formaldehyde, acetaldehyde, naphthalene, a primary amine particularly aromatic, indole, skatole, tryptophan, urobilinogen, pyrrole, benzene, ethylbenzene, toluene, xylene, styrene, naphthalene, a halide compound, a radionuclide, a metal or radioactive isotope of said metal, a molecule of biological interest, a molecule of pharmacological interest, a toxin, a carbohydrate, a peptide, a protein, a glycoprotein, an enzyme, an enzymatic substrate, an hormone, a polyclonal or monoclonal antibody, an antibody fragment, a nucleotide molecule, an advantageously organic pollutant of water or air, a bacterium, or a virus.

51. The method according to claim 49, wherein said fluid is selected from among a biological fluid; a sample from a culture medium or biological culture reactor such as a cell culture of higher eukaryotes, yeasts, fungi or algae; a liquid obtained from one or more animal or plant cells; a liquid obtained from animal or plant tissue; a food matrix sample; a sample from a chemical reactor; tap water, river water, pond water, lake water, sea water, aquarium water, cooling water from air-conditioning systems or cooling towers; a liquid product, an effluent or wastewater from intensive farming or from industries or plants in the chemical, pharmaceutical cosmetic or nuclear fields; a pharmaceutical product; a cosmetic product, a perfume, or one of the mixtures thereof.

52. The method according to claim 49, wherein said step (ii) consists of covalently grafting a reagent, either directly or indirectly, on a surface of the glass having bimodal macroporous and mesoporous porosity.

53. The method according to claim 52, wherein said step (ii) consists of covalently grafting a reagent, either directly or indirectly, on a surface inside the pores of this glass.

54. The method according to claim 52, wherein the said reagent is selected from the group consisting of hydroxyl, thiol, azide, epoxide, aziridine, amine, phosphine, phosphonate, phosphine oxide, oxime amide, carbamate, nitrile, isocyanate, nitro, amide, halide in particular alkyl halide, carboxylic acid and ester functions; a molecular probe; a carbohydrate; a peptide; a protein; a glycoprotein; an enzyme; an enzymatic substrate; a toxin; a polyclonal or monoclonal antibody; an antibody fragment; a nucleotide molecule; a peptide nucleic acid and an aptamer such as a DNA aptamer or RNA aptamer, and a ferrocyanide (nano)particle.

55. Glass having bimodal macroporous and mesoporous porosity able prepared using the method of claim 18.

56. Functionalised glass having bimodal macroporous and mesoporous porosity prepared according to claim 49, at step (ii).
